(19) United States
(12) Patent Application Publication
(10) Pub. No.: US 2017/0080504 A1
(43) Pub. Date: Mar. 23, 2017

(54) TABLE SAW FENCE HOLD DOWN DEVICE

(71) Applicant: Henry Warkentin, Slave Lake (CA)

(72) Inventor: Henry Warkentin, Slave Lake (CA)

(21) Appl. No.: 14/858,001

(22) Filed: Sep. 18, 2015

(51) Int. Cl. B23D 47/04; B23D 45/06

(52) U.S. Cl. CPC B23D 47/04; B23D 45/06

(57) ABSTRACT

A table saw hold-down device comprising a straight edge located on a horizontal planar surface, wherein the horizontal planar surface includes a table saw. The straight edge includes a flat surface against which an item is placed when being cut by the table saw, and wherein the flat surface is perpendicular to the horizontal planar surface. Two or more wheels are movably coupled to the straight edge and are configured such that when said item is placed against the flat surface of the straight edge when being cut, and the wheels contact said item, the wheels rotate to accommodate movement of said item along the straight edge. At least one spring loaded mechanism coupled to the wheels is configured for moving the wheels down such that when said item is placed against the straight edge when being cut, the spring loaded mechanism pushes the wheels against said item.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to field of table saws, and more specifically to the field of hold-down devices for table saws.

### BACKGROUND

Wood is one of the world's greatest natural resources. Wood is one of the essential building materials for many types of goods and structures. Wood can be used to build furniture, structures, windows, doors, trusses, and many other items. In order to make such items wood must be cut to various shapes and dimensions.

One way to cut wood is by using a saw known as a table saw. A table saw is a woodworking tool consisting of a circular saw blade that is driven by an electric motor and gears. The saw blade protrudes through the surface of a table or a horizontal planar surface, which provides support for the material, usually wood, being cut. A table saw allows wood to be a cut efficiently. Typically, a fence or straight edge, perpendicular to the table or horizontal planar surface, is used in order to guide a piece of wood or item being cut.

However, table saws do have disadvantages. One disadvantage of using a table saw is that when cutting the item, the upward force exerted by the saw on the item causes the item to move upwards or “climb” and pull away from the table. The climbing of the item causes inaccurate cuts which may result in waste. Climbing also has safety issues and may also cause injury to a table saw operator.

Another disadvantage is known as a kickback. Many times when using a table saw, kickback happens which may cause injury to an operator. Kickback happens when the blade catches a piece of wood or item and violently throws it back to the front of the saw, towards the operator. It can be thrown very hard and can injure the operator. It is not uncommon for the object to have high enough velocity to become embedded in a wall or to cause other damage or injury. A kickback can be fatal.

Currently, prior art has been designed to hold down the wood so that kickbacks are reduced. However, the existing prior art fails to adequately hold-down the wood against the table and saw blade. Additionally, the current prior art designs are inadequate because it is difficult to install and uninstall when working which creates a loss of time and increase in hassle for the operator. Because of the hassle to uninstall and install many operators do not use the current prior art, which may eventually cause injury to the operator.

As a result, there exists a need for improvements over the prior art and more particularly for an improved and safer table saw hold-down device.

### SUMMARY

A table saw hold-down device is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a table saw hold-down device is disclosed. The system comprises a straight edge located on a horizontal planar surface including the table saw. The straight edge includes a flat surface against which an item is placed when being cut by the table saw. The flat surface is perpendicular to the horizontal planar surface. One or more wheels are movably coupled to the straight edge. The wheels are located longitudinally and in series in relation to the straight edge such that an axle of each of the wheels is perpendicular to the flat surface of the straight edge. The wheels are also configured such that when said item is placed against the flat surface of the straight edge when being cut, and the wheels contact said item, the wheels rotate to accommodate movement of said item along the straight edge. At least one spring loaded mechanism coupled to the wheels. The spring loaded mechanism is configured for moving the wheels down such that when said item is placed against the straight edge when being cut, the spring loaded mechanism pushes the wheels against said item.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a perspective view of an illustration of a table saw hold-down device with a pair of wheels in an up position, according to an example embodiment;

FIG. 2 is a top view of an illustration of the table saw hold-down device with the pair of wheels in the up position, according to an example embodiment;

FIG. 2A is a top view of an illustration of the table saw hold-down device with the pair of wheels in the up position with the wheels moved away from a flat surface of the table saw hold-down device, according to an example embodiment;

FIG. 3 is a partially exploded perspective view of an illustration of the table saw hold-down device with the pair of wheels in a down position, according to an example embodiment;

FIG. 3A is a perspective view of an illustration of the table saw hold-down device with the pair of wheels in a down position, according to an example embodiment;

FIG. 4 is a top view of an illustration of the table saw hold-down device with the pair of wheels in the down position, according to an example embodiment; and,

FIG. 5 is a top view of an illustration of a bar clamp of the table saw hold-down device, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a hold-down device that is easier to use. The disclosed embodiments also reduce and prevent kick-back and help with the accuracy of cuts completed by the table saw. These disclosed embodiments are designed to remain on the saw fence when not in use which reduces the amount of time required by an operator to use the hold-down device when needed. The disclosed embodiments also allow for easy adjusting for different thicknesses of wood or other items that are being cut, which makes it more likely that an operator will use the device and thereby reducing likelihood and amount of injury. The disclosed embodiments also improve over the prior art by providing a less difficult way to remove the hold-down device from the item after being cut thereby reducing the amount of time required by an operator when cutting items. The disclosed embodiments also improve over the prior art by providing a housing that is movably attached to the straight edge such that the movable housing allows the wheels to not interact with a flat surface of the hold down device and as a result, very thick or tall pieces may be cut and vertical cutting may be completed.

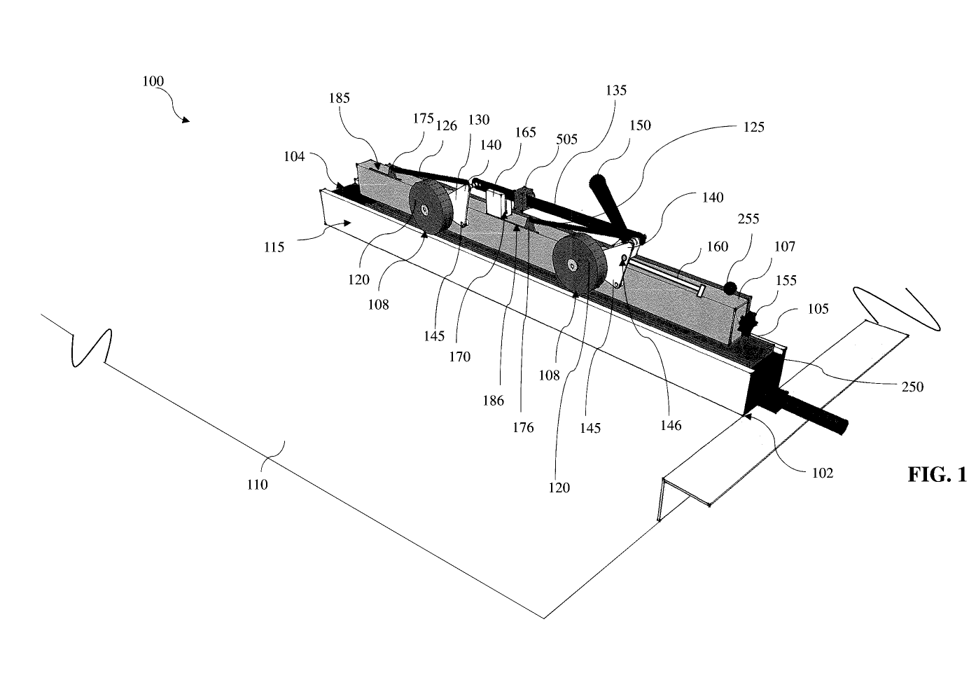

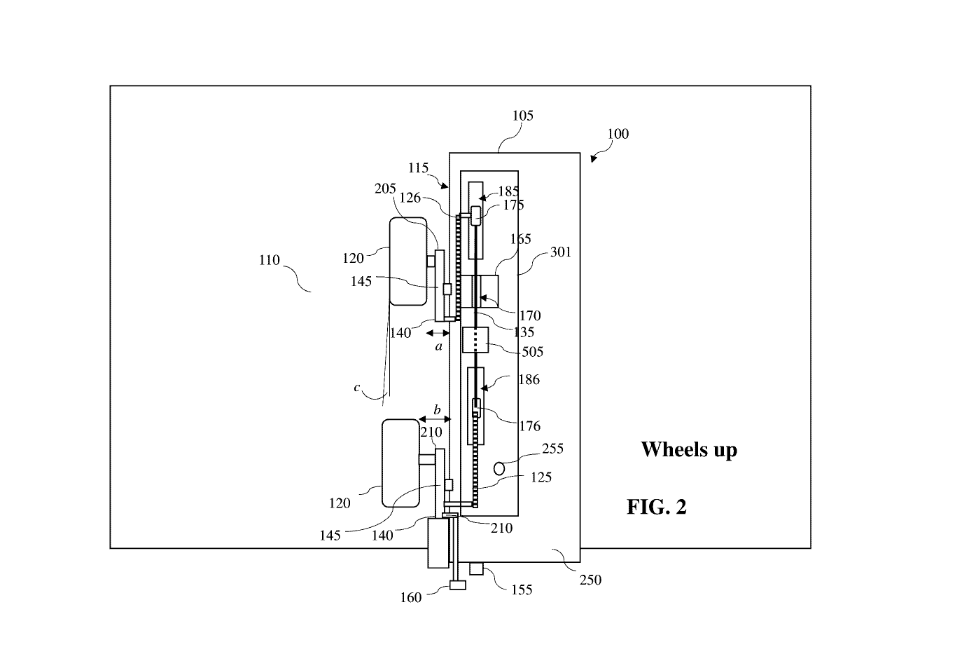

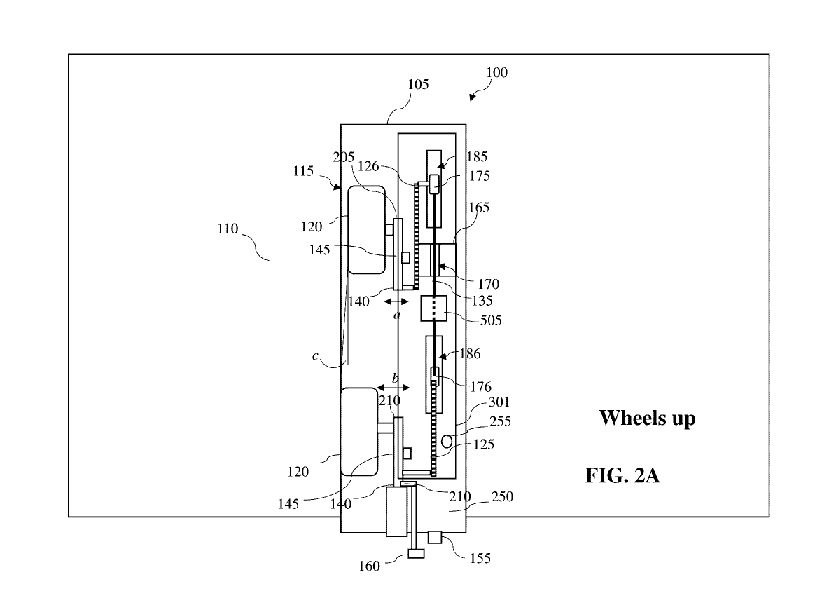

FIGS. 1, 2 and 2A will now be discussed together. FIG. 1 is a perspective view of an illustration of a table saw hold-down device 100 with a pair of wheels 120 in an up position, according to an example embodiment. FIG. 2 is a top view of an illustration of the table saw hold-down device with the pair of wheels in the up position, according to an example embodiment. FIG. 2A is a top view of an illustration of the table saw hold-down device with the pair of wheels in the up position with the wheels moved away from a flat surface of the table saw hold-down device, according to an example embodiment. The table saw hold-down device is located on a horizontal planar surface or table 110. When in the up position the wheels are positioned such that an item can easily be placed on or removed from the horizontal planar surface. For very thick pieces, in one embodiment, the wheels can be moved away from the flat surface 115 to facilitate cutting of pieces (further explained below). The horizontal planar surface may comprise wood, metal, plastic, or any other material suitable for cutting wood. Such materials are well known to those skilled in the art.

A straight edge or table saw fence 105 is located on the horizontal planar surface. The straight edge includes a flat surface 115 against which an item or piece of wood (not shown) is placed when being cut by the table saw. The flat surface 115 is perpendicular to the horizontal planar surface or table. The straight edge has a top or upward facing surface 107 opposing a bottom surface. The top surface is also perpendicular to the flat surface 115. The table saw hold-down device as a front end 102 opposing a back or rear end 104. The front end of the table saw hold-down device is proximate to and operator when the operator is using the device. The rear end of the table saw hold-down device is distal to and operator when the operator is using device.

One or more wheels 120 are coupled to the straight edge. In the present embodiments, two wheels are shown, however this is not meant to be a limitation and more wheels may be used. The wheels are located longitudinally and series in relation to the straight edge such that an axle of each of the wheels is perpendicular to the flat surface of the straight edge. The wheels are configured such that when an item or piece of what is placed against the flat surface of the straight edge when being cut, and when the wheels contact an item being cut, the wheels rotates to accommodate movement of the item along the straight edge. In one embodiment, the wheels are configured to have a one-way bearing that only allow the wheels to roll in one direction and thereby only allow an item to be moved from the front end of the hold-down device to the rear end of the hold-down device. The one-way bearings assist with reducing or preventing kickbacks by preventing the wheels from rotating backwards towards the front end of the hold-down device. The hold-down device may be designed to be an integral table fence or may be adapted to be affixed to an existing table fence using fasteners, such as a bolt and screw or cam-lock device. In other embodiments, the bearings may be used other than a one-way bearing. As illustrated in FIG. 2A, in one embodiment the wheels may be movably attached to a housing 301. The housing may be movably attached to the hold down device such that the wheels can be moved away from the flat edge 115 and toward the flat edge. In one embodiment, the downward facing side of the housing 301 may be guided by tracks such that the housing 301 may be moved away from the flat surface 115 (as illustrated in FIG. 2A) and towards the flat surface (as illustrated in FIG. 2). In other embodiments, other means of sliding or swinging the housing towards and away from the flat surface may be used. Other means of movably attaching the housing so that it can be moved towards and away from the flat surface 115 are also contemplated and within the spirit and scope of the invention.

The housing is also configured to be locked away from the flat edge (as illustrated in FIG. 2A) and is configured to be locked so that the wheels are positioned above the flat edge (as illustrated in FIG. 2). In one embodiment, a pin 255 with a spring mechanism (biasing downward) may be used to lock the housing 301 into position above the flat edge and away from the flat edge. The pin can be an elongated body that is vertically aligned within the housing and having a terminating end. The pin is sized such that it spans the body of the housing 301 such that the terminating end of the pin passes through an orifice on the downward facing surface of the housing and at the same time allows an operator to access the pin from the upward facing surface of the housing. In one embodiment the upward facing surface 250 of the straight edge may comprise a first orifice (not shown) and a second orifice (not shown) and each orifice is adapted to receive the terminating end of the pin. Each of the orifices on the upward facing surface 250 (not shown) are adapted to receive the end of the pin passing through the downward facing surface of the housing 301 and prevent the housing from moving with respect to the straight edge 105. The first orifice (not shown) is positioned along upward facing surface 250 such that when the terminating end of the pin enters the first orifice it locks the housing 301 in a position such that the wheels are above the flat surface 115 (as illustrated in FIG. 2). The second orifice (not shown) is positioned along upward facing surface 250 such that when the pin enters the second orifice it locks the housing 301 in a position such that the wheels are away from the flat surface 115 (as illustrated in FIG. 2A). In operation, a user may apply upward force on the pin to compress the spring mechanism (not shown) so as allow the housing to slide or move away from and toward the flat surface by removing the terminating end of the pin from the first or second orifice. When the housing is in a desired position, a user can remove the upward force on the pin such that the spring biases downward such that the pin enters into the first or second orifice thereby locking the housing. It should be noted that other locking means may be used and are within the spirit and scope of the invention.

When the housing and wheels are positioned away from the flat surface, and as a result, very thick or tall pieces may be cut and vertical cutting may be completed that would not otherwise be able to be completed. This sliding or movable feature of the housing makes it easier for an operator to move the hold down device when cutting very tall or thick pieces. Additionally, this feature also makes it easy for an operator to reposition the hold-down device so that the wheels may be moved toward the flat surface, thus making it more likely than an operator will use the device.

A front spring-loaded mechanism 125 is coupled to the front wheel and a rear or back spring-loaded mechanism 126 is coupled to the rear or back wheel. The spring loaded mechanisms are configured for moving the wheels down such that when an item is placed against the straight edge when being cut, each of the spring-loaded mechanisms push the wheels against the item. The spring-loaded mechanisms or springs may include a gas spring, a tension spring, or a coil spring or any other mechanism that provides a downward pulling force. In the present embodiment, each of the wheels is affixed to a triangular planar shaped body 130. In the present embodiment, each wheel is movably connected to a first apex 205 (better illustrated in FIG. 2) of each triangular planar shaped body. As mentioned above, the axle of each wheel includes a one-way bearing such that the wheel only rotates in one direction. A substantially flat or planar horizontal bar 135 spans between the one or more planar shaped bodies, wherein the horizontally aligned bar is movably connected to a second apex of each triangular shaped body. Each triangular shaped body is movably connected to the straight edge at a third apex 145 of the triangular shaped body. The shape and configuration of the triangular shaped body is adapted such that as each triangular planar shaped body rotates in relation to the straight edge, the wheels can be moved between an up position and a down position.

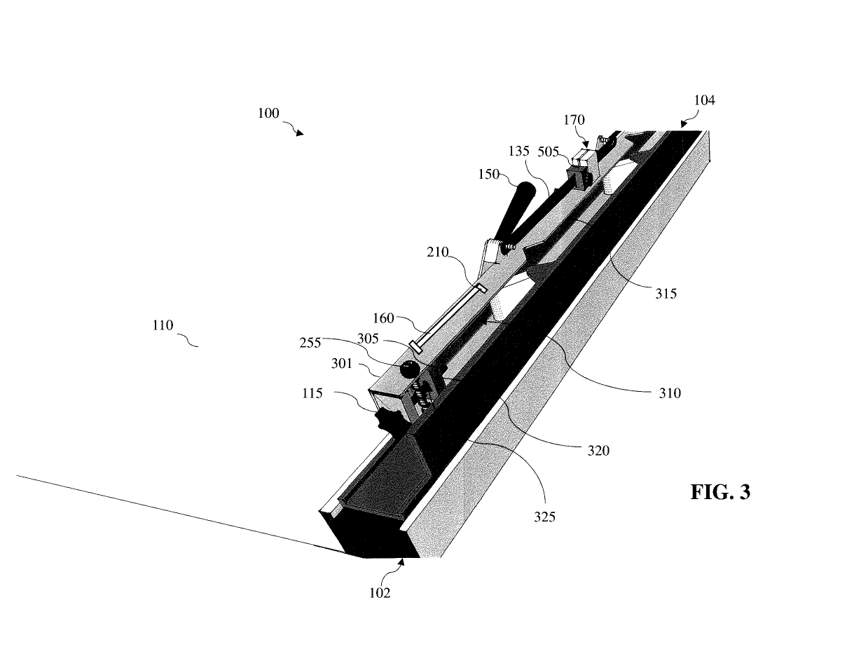

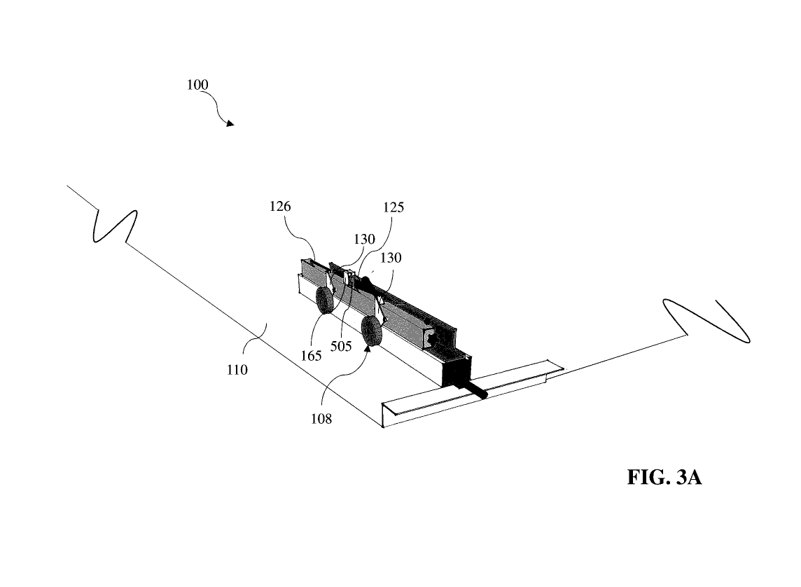

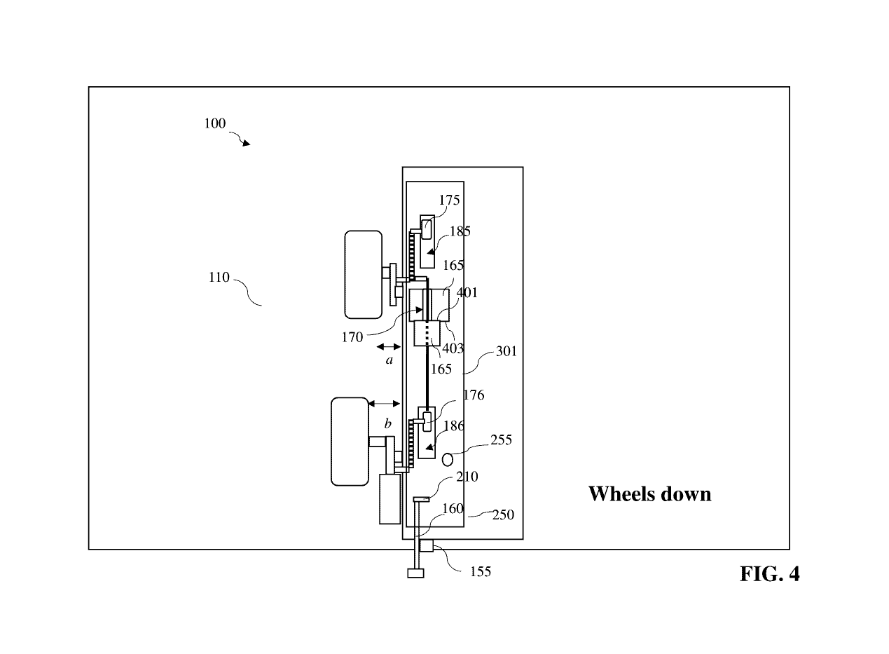

In the present embodiment, a first end of the front spring-loaded mechanism or spring 1265 is coupled to the second apex of the front triangular shaped body and the second end of the front spring is connected to a tab 176 that protrudes perpendicularly upward from the upward facing or top surface 107 of the straight edge. A first end of a rear spring-loaded mechanism or spring 126 is coupled to the second apex of the rear or back triangular shaped body and the second end of the rear spring is connected to a tab 175 that protrudes upward from the top surface or upward facing surface of the straight edge. In the present embodiments, the rear and front tabs are triangular shaped and may be moved both forward and backwards within an elongated slot 185, 186 on the top surface of the straight edge (further explained in FIGS. 3 and 4) such as to increase or decrease an amount of tension or downward force provided by the spring-loaded mechanisms or springs. The position of tabs in relation to the second apex of the triangular shaped body causes each of the springs or spring-loaded mechanisms to be in an extended or stretched state. As a result of this extended or stretched state, the springs act on each of the triangular shaped planar bodies causing a downward force to push the wheels against an item being cut or the horizontal planar surface 110. This downward force assist in preventing the item being cut from moving upwards.

In FIGS. 1, 2 and 2A, each triangular shaped body is positioned such that the wheels are in the up position. When in the up position, the item being cut is able to be removed or installed with greater ease in the prior art. Additionally, when in the up position and moved away from the flat surface 115 (as illustrated in FIG. 2A), the wheels are not above the flat surface, do not interact with the flat surface and as a result such configuration provides an operator with the ability to cut larger or thicker pieces or to perform vertical cuts that would otherwise not be feasible when the wheels interact with the flat surface 115 (even when in the up position). When in the down position (as illustrated in FIGS. 3 and 4), the movable wheels contact the piece of wood or item being cut. When in the down position, the wheels rotate to accommodate movement of the item along the straight edge.

When an item is placed against the straight edge 115 when being cut, the front and back spring-loaded mechanisms or springs are pulled down due to the force pulling the springs back to their compressed or non-stretched state. Each spring-loaded mechanisms pulls the wheels downward and a downward force provided by the spring loaded mechanisms prevents the items from moving upwards. As a result, kickbacks are prevented and reduce by the table saw hold-down device.

A handle 150 is attached to the second apex on the front spring or spring-loaded mechanism which can be used to facilitate moving the wheels between the up position and down position. Because the elongated horizontal bar spans from the second apex of the front triangular planar shaped body to the rear triangular planar shaped body, when in a fully down position and when a force directed towards the front end of the table saw hold-down device is applied to the handle located on the front triangular shaped body, both the front and back springs can be stretched and thereby moving the wheels into the up position off the horizontal planar surface and out of the way of the piece of wood or item.

The spring-loaded mechanism can be configured to being locked in the fully up position. To lock the spring-loaded mechanism in the fully locked position sufficient force must be applied to the triangular planar shaped bodies such that the springs remain in an expanded position. In the present embodiments, the mechanism for blocking the table saw hold-down device in the fully up position includes an aperture 146 on the front triangular planar shaped body. The aperture is adapted to receive a protruding finger 210 (illustrated in FIG. 1) of a catching mechanism 160 that applies a force such that the springs remain expanded or extended so as to lock the table saw hold-down device in the fully up position. In the present embodiments, the catching mechanism includes an elongated bar shape body having a protruding finger or hook 210 at one end distal to the front end of the hold-down device and a second end opposing the catching mechanism that is movably affixed to the top or upward facing surface 107 of the straight edge. In operation, when the wheels are in the up position, the protruding finger is hooked into aperture 146 preventing the spring-loaded mechanisms from moving to the current press or non-stretched position. The second end of the catching mechanism is movably affixed to the top surface of the straight edge such that the catching mechanism applies force to the front triangular planar shaped body to retain the front and rear springs in the expanded or extended position. In order to move into the down position, a force must be applied on the handle 150 towards the front end of the straight edge such that the protruding finger can be disengaged or moved from the aperture of the front triangular planar shaped body. After the catching mechanism is disengaged from the front triangular planar shaped body, the spring-loaded mechanisms or springs can move the wheels to the down position. The above means of locking the table saw hold-down device in an up position is a non-limiting embodiment and other means are also within the spirit and scope of the invention.

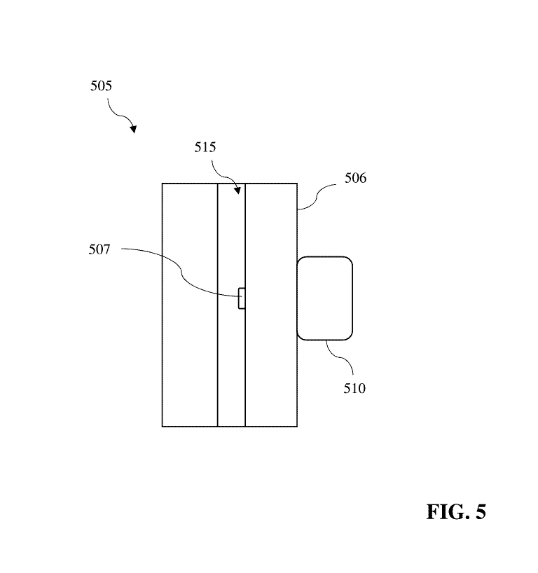

The table saw hold-down device may also be configured so that when in the fully down position a vertical relief or height defined by the dimension between the bottom end 108 of the wheels and the horizontal planar shaped body is adjustable. Adjusting the height or vertical relief between the horizontal planar shaped body and the bottom end of the wheels can be used to accommodate for varying thicknesses of material that is being cut as well as for personal preference of the operator. In one embodiment, the means for adjusting the height of vertical relief includes a slitted block 165 affixed to or positioned on the top or upward facing surface of the straight edge and in between the front and back triangular planar shaped bodies. The slitted block comprises a substantially box shaped body having a u-shaped channel 170 having its mouth facing upwards adapted for receiving the elongated horizontally aligned bar 135. Additionally, the means for adjusting the vertical relief or height also includes a shaft or bar clamp 505 (better illustrated in FIG. 5). The bar clamp is adapted for being clamped onto the elongated horizontally aligned bar and can be positioned between the slitted block and the front end of the straight edge. In operation, to adjust the vertical relief or height between the horizontal planar body and the bottom end 108 of the wheels, a user can adjust the position of the shaft or bar clamp, either towards or away from the front end, on the horizontally aligned bar such that when the wheels are moved into the down position the bar clamp abuts the slitted block. If no vertical relief is required, then the shaft claimed may be moved or positioned on the horizontally aligned bar such that the bar clamp does not abut the slitted block. If vertical relief is required, then the bar clamp can be moved or positioned along the flattened horizontally aligned bar such that the bar clamp does abut the slitted block when in the fully down position thereby preventing the bottom of the wheels from abutting the horizontal planar surface 110 and providing vertical relief or reducing the amount of downward force provided by the wheels on the item being cut.

Referring to FIG. 2., the wheels 120 may be affixed onto the triangular shaped body such that the distance between the front wheel and the flat edge 115 illustrated as dimension b is greater than the distance between the rear wheel and the flat edge illustrated as dimension a. As a result of the difference in dimensions, when a piece of wood is cut the difference in dimensions a and b causes the item or would to be pulled towards the flat surface 115. In one embodiment, the difference in dimensions a and b may define angle c. In one embodiment, angle c maybe 5°, however other angles may be used.

FIGS. 3, 3A and 4 illustrate the table saw hold down device in the down position. FIG. 3 is a partially exploded perspective view of an illustration of the table saw hold-down device with the pair of wheels in a down position, according to an example embodiment. Some of the components of the table saw hold-down device and not been shown so that the reader can more easily view the described embodiments. FIG. 3A is a perspective view of an illustration of the table saw hold-down device with the pair of wheels in the down position, according to an example embodiment. FIG. 4 is a top view of an illustration of the table saw hold-down device with the pair of wheels in the down position, according to an example embodiment. In one embodiment, the amount of tension or downward force provided by the spring-loaded mechanisms may be adjustable. To adjust the tension or downward force, the position of the tabs 175, 176 (illustrated in FIGS. 1, 2 and 4) protruding perpendicularly from the top surface or upward facing 107 of the straight edge can be moved between the rear and front end of the table saw hold-down device. For example, the front and rear tabs can be moved towards the rear end of the table saw hold-down device in order to increase the amount of tension or downward force. To decrease the amount of downward force attention on the springs, the tabs can be moved towards the front of the table saw hold-down device.

In one embodiment, the means to move the tabs 175, 176 frontwards and backwards includes elongated slots 185, 186 (illustrated in FIGS. 1, 2, and 4) along the top or upward facing surface 107 of the straight edge. The elongated slots are adapted such that a portion of the tabs can protrude through the elongated slots. A portion of the straight edge comprises a housing 301 defining an inside volume adapted to house an elongated L-shaped body 310. The L-shaped body has a long leg 315 that spans a substantial portion from the front end to the rear end of the inside of the housing and a short leg 320 perpendicular to the long leg. The short leg includes an aperture 325. The front and rear tabs are affixed to the long leg (not shown) such that the tabs protrude through the elongated slots when the L-shaped body is positioned within the housing. The aperture is threaded and adapted to receive a threaded lead screw 305. The lead screw is connected to a knob on the outside of the housing such that when rotational forces are applied to the knob, the lead screw causes the long leg to move frontwards and backwards along the longitudinal axis of the housing of the straight edge, which in turn moves the tabs 175, 176 frontwards and backwards.

For example, in FIG. 4, the tabs have been positioned towards the rear of the elongated slots. In FIG. 2, the tabs have been positioned towards the center of the elongated slots. As a result, the tension, or downward force, supplied by the springs when in the fully down position is greater in FIG. 4 than in FIG. 2. In operation, in order to adjust the tension or decrease downward force provided by the springs, and operator applies rotational forces to knob 155 in order to move the L-shaped body thereby moving the tabs within the elongated slots. FIG. 4 also illustrates that the protruding finger 210 of the catching mechanism 160 has been removed from the aperture 146 (illustrated in FIGS. 1 and 2 and explained above) thereby allowing the downward force of the spring loaded mechanism or springs to move the wheels downward. Additionally, FIG. 4 also illustrates the U-shaped channel 170 of the slitted block receiving the elongated bar and having the rear would end 401 of bar clamp 505 abutting the frontward end 403 of the slitted block thereby providing vertical relief (not shown) between the bottom and of the wheels and the horizontal planar surface.

Referring now to FIG. 5, FIG. 5 is a top view of an illustration of a shaft or bar clamp 505 of the table saw hold-down device, according to an example embodiment. The bar clamp includes a rectangular shaped body 506 having a U-shaped channel 515. In another embodiment, the channel may be rectangular shaped, wherein the rectangular shaped channel spans from a first end of the rectangular shaped body to its second end (along the rectangular shaped channel's longitudinal axis). When the rectangular shaped embodiment is utilized, the bar clamp can be maintained on the horizontally aligned bar to prevent loss by the operator. Both the rectangular shaped channel and the U-shaped channel are adapted for being received by the elongated horizontally aligned bar 135. In one embodiment, a threaded screw 507 is adapted to be inserted into an aperture (not shown) in body 506, which has corresponding threads to the threaded screw and is adapted for receiving the threaded screw. In one embodiment, in order to clamp the bar clamp onto the elongated horizontal aligned bar, the U-shaped channel of the bar clamp is received onto the elongated horizontally aligned bar in a desired position. Next, and operator can apply rotational forces to the threaded screw 507 in order to insert the screw into the aperture of the rectangular shaped body 506 such that the end of the terminal end of the screw enters into the U-shaped channel 515 (or a rectangular shaped body 506 with a slot or hole from one end through to the other). As the screw enters the U-shaped channel, the terminal end of the screw abuts the elongated horizontally aligned bar forming a friction fit and thereby clamping the bar clamp onto the elongated shaped bar or shaft.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A table saw hold-down device, comprising:
a straight edge located on a horizontal planar surface including the table saw, wherein the straight edge includes a flat surface against which an item is placed when being cut by the table saw, and wherein the flat surface is perpendicular to the horizontal planar surface;
two or more wheels movably coupled to the straight edge, wherein the wheels are located longitudinally and in series in relation to the straight edge such that an axle of each of the wheels is perpendicular to the flat surface of the straight edge, and wherein the wheels are configured such that when said item is placed against the flat surface of the straight edge when being cut, and the wheels contact said item, the wheels rotate to accommodate movement of said item along the straight edge; and
at least one spring loaded mechanism coupled to the wheels, the spring loaded mechanism configured for moving the wheels down, such that when said item is placed against the straight edge when being cut, the spring loaded mechanism pushes the wheels against said item.

2. The table saw hold-down device of claim 1, wherein when said item is placed against the straight edge when being cut, and when the spring loaded mechanism pushes the wheels down, a downward force provided by the spring loaded mechanism prevents said item from moving upward.

3. The table saw hold-down device of claim 1, wherein the table saw hold-down device further comprises:
each of said two or more wheels movably connected to a first apex of a planar shaped body;
a horizontally aligned bar spanning between said planar bodies, wherein the horizontally aligned bar is movably connected to a second apex on each planar body;
a lever attached to said second apex on one of the planar bodies; and,
wherein a third apex of each of the triangular planar shaped bodies is movably connected to the straight edge.

4. The table saw hold-down device of claim 1, wherein the spring loaded mechanism is configured for being locked in a fully up position.

5. The table saw hold-down device of claim 1, wherein the two or more wheels comprise a one way bearing such that the wheels roll in a single direction.

6. The table saw hold-down device of claim 1, wherein the spring loaded mechanism is configured such that an amount of downward force provided by said spring loaded mechanism is adjustable.

7. The table saw hold-down device of claim 1, wherein the spring loaded mechanism comprises at least one tension spring.

8. The table saw hold-down device of claim 1, wherein the spring loaded mechanism comprises at least one gas spring.

9. The table saw hold-down device of claim 1, wherein the spring loaded mechanism comprises at least one coil spring.

10. The tables saw hold-down device of claim 14, wherein the wheels are movably coupled to the straight edge such that the wheels can be moved away from and towards said flat surface against which an item is placed.

11. A table saw hold-down device, comprising:
a straight edge located on a horizontal planar surface including the table saw, wherein the straight edge includes a flat surface against which an item is placed when being cut by the table saw, and wherein the flat surface is perpendicular to the horizontal planar surface;
two wheels movably coupled to the straight edge, wherein the wheels are located longitudinally and in series in relation to the straight edge such that an axle of each of the wheels is perpendicular to the flat surface of the straight edge, and wherein the wheels are configured such that when said item is placed against the flat surface of the straight edge when being cut, and the wheels contact said item, the wheels rotate to accommodate movement of said item along the straight edge;
each of said two wheels movably connected to a first apex of a triangular planar shaped body;
a horizontally aligned bar spanning between said triangular planar shaped bodies, wherein the horizontally aligned bar is movably connected to a second apex on each triangular planar shaped body;
a lever attached to said second apex on one of the triangular planar shaped bodies;
wherein a third apex of each of the triangular planar shaped bodies is movably connected to the straight edge;
a spring loaded mechanism coupled to the wheels, wherein a first end of each of said spring-loaded mechanisms is coupled to each of the second apexes of said triangular planar shaped bodies and wherein a second end of each of said spring-loaded mechanisms is coupled to a tab protruding from a top surface of the straight edge such that each spring-loaded mechanisms provides a downward force to the wheels; and,
wherein the spring loaded mechanism is configured for moving the wheels down, such that when said item is placed against the straight edge when being cut, the spring loaded mechanism pushes the wheels against said item, and wherein said downward force provided by the spring loaded mechanism prevents said item from moving upward.

12. The table saw hold-down device of claim 11, wherein the spring loaded mechanism is configured for being locked in a fully up position.

13. The table saw hold-down device of claim 12, wherein the two wheels comprise a one way bearing such that the wheels roll in a single direction.

14. The table saw hold-down device of claim 13, wherein the spring loaded mechanism is configured such that an amount of tension provided by said spring loaded mechanism is adjustable.

15. The table saw hold-down device of claim 14, wherein the spring loaded mechanism comprises at least one tension spring.

16. The table saw hold-down device of claim 15, wherein the spring loaded mechanism comprises at least one gas spring.

17. The table saw hold-down device of claim 16, wherein the spring loaded mechanism comprises at least one coil spring.

18. A table saw hold-down device, comprising:
a fence located on a horizontal planar surface including the table saw, wherein the fence includes a flat surface against which an item is placed when being cut by the table saw, and wherein the flat surface is perpendicular to the horizontal planar surface;
one or more wheels movably coupled to the fence, wherein the wheels are located longitudinally such that an axle of each of the wheels is perpendicular to the flat surface of the fence, and wherein each wheel is configured such that when said item is placed against the flat surface of the fence when being cut, and each wheel contacts said item, each wheel rotates to accommodate movement of said item along the fence; and
at least one spring loaded mechanism coupled to each wheel, the spring loaded mechanism configured for moving each wheel down, such that when said item is placed against the fence when being cut, the spring loaded mechanism pushes each wheel against said item.

19. The table saw hold-down device of claim 1, wherein when said item is placed against the fence when being cut, and when the spring loaded mechanism pushes each wheel down, a downward force provided by the spring loaded mechanism prevents said item from moving upward.

20. The table saw hold-down device of claim 17, wherein the table saw hold-down device further comprises:
each wheel is movably connected to a first apex of a planar shaped body;
a horizontally aligned bar spanning between said planar bodies, wherein the horizontally aligned bar is movably connected to a second apex on each planar shaped body;
a lever attached to said second apex on one of the planar shaped bodies;
a third apex of each of the triangular planar shaped bodies is movably connected to the straight edge; and,
wherein a first end of each of said spring-loaded mechanisms is coupled to each of the second apexes of said planar shaped bodies and wherein a second end of each of said spring-loaded mechanisms is coupled to a tab protruding from a top surface of the straight edge such that each spring-loaded mechanisms provides a downward force to each wheel.
